(19) United States
(12) Patent Application Publication
(10) Pub. No.: US 2008/0052702 A1
(43) Pub. Date: Feb. 28, 2008

(54) Firmware update method and system utilizing digital broadcasting system

(75) Inventor: Yun-Hsiang Chuang, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Multimedia & Telecom Corporation, Taipei City (TW)

(21) Appl. No.: 11/483,115

(22) Filed: Jul. 7, 2006

(51) Int. Cl. G06F 9/44

(52) U.S. Cl. 717/170

(57) ABSTRACT

A firmware update method and system utilizing a digital broadcasting system are provided. The method includes the following steps: perform the version check procedure of the firmware program, receive the latest version of the firmware program, verify if the firmware program update procedure is to be performed, replace the firmware program of the original version with the firmware program of the latest version, verify the completion of the update procedure, re-execute a system power-up procedure, and reboot the system with the latest version firmware program, thus further facilitate the firmware program update.

### BACKGROUND

1. Field of Invention

The invention relates to a firmware update method and system thereof, and in particular to a firmware update method and system realized through a digital broadcasting system.

2. Related Art

Nowadays, the ordinary consumer electronic products are provided with the capability of updating firmware. Usually, in addition to having the benefit and advantage of debugging and preventing system power going down, the firmware update function is used to enhance service capability of the electronic products and the system stability. In general, the user end must be connected to a specific web-site through Internet for downloading the latest version of the firmware update file, thus being able to execute the related firmware update operation. For example, when a multimedia player, having only simplified Chinese characters version files requiring the operation interface used for ordinary Chinese character version files, or another language version file, the firmware update function may be utilized to enable the multimedia player to support the multi-language operation interface. Another occasion requiring a firmware update function is that, for instance, when a Compact Disk (CD) player is not capable of recognizing/identifying a new version of a CD, then the firmware update function may be utilized to enable the CD player to recognize/identify and read the CD. However, in implementing the above-mentioned firmware update function, the user end must be provided with a computer system, to proceed with the execution of the related firmware update operation. Not being provided with a computer system is quite inconvenient for the user.

In this respect is referred to Taiwan Patent Publication Number I248027, wherein an on-line firmware update system and method is disclosed. A control device is utilized to manipulate the firmware update procedure of a plurality of electronic devices through a browser in a remote control manner, by means of a web server, to timely display the execution status of the firmware update procedure. As such, the firmware of a plurality of electronic devices can be updated simultaneously through the network.

Though, in the above-mentioned patent, a single control device is utilized to perform the firmware update procedure of a plurality of electronic devices, however, in this patent, a computer system has still to be utilized at the user end to proceed with the related firmware update operation, thus this type of firmware update is still not quite convenient.

Therefore, in order to overcome the shortcomings and drawbacks of the prior art, the provision of a firmware update method and system utilizing a digital broadcasting system, so that the users may proceed with the firmware program update procedure without having to go through a computer system, is a very important task that has yet to be accomplished in this field.

### SUMMARY OF THE INVENTION

According to one aspect of the invention, a firmware update method by using a digital broadcasting system is provided. The firmware program is updated through a digital broadcasting system, including the following steps: Firstly, perform the version check procedure of the existing firmware program at the user end. Next, receive a firmware program of the latest version, wherein the firmware program is transmitted through a Main Service Channel (MSC) of a digital broadcasting system. Then, verify and make sure that the update procedure of firmware program is to be performed. Subsequently, replace the firmware program of the original version with the firmware program of the latest version. Then, verify the completion of the update procedure and re-execute the system power-up procedure. And finally, reboot the system utilizing the latest version firmware program.

In the above description, after the step of receiving a latest version firmware program, the method further includes the step of displaying the difference information between the latest version firmware program and the original version firmware program.

Moreover, after the step of replacing the original version firmware program with the latest version firmware program, the method of the invention further includes the step of generating a message notifying the completion of the firmware update.

According to another aspect of the invention, a firmware update system utilizing a digital broadcasting system is provided, wherein the firmware program update procedure is performed at the system end and user end of the digital broadcasting system. In this respect, the system includes: a firmware program database, used to store at least a firmware program of the latest version, and a first data receiving/transmitting unit, used to receive and transmit a firmware program through digital broadcast communication, wherein the firmware program is transmitted via the Main Service Channel (MSC) of a digital broadcasting system.

Furthermore, the user end includes: a second data receiving/transmitting unit, used to receive and transmit the firmware program through digital broadcast communication; a firmware update unit, used to execute the firmware program version checking procedure and then perform the update procedure; a program temporary storage unit, used to temporarily store the received latest version firmware program; a firmware program unit, used to store the latest version firmware program after the completion of the update procedure executed by the firmware update unit, wherein, in practice, the firmware program unit is a non-volatile memory (for example, the Flash Read-Only-Memory (ROM) or an Electrically Erasable Programmable Read-Only-Memory (EEPROM)); and a system reset unit, used to re-execute the system power-up procedure after the completion of the update procedure.

A digital broadcasting system is used for the application of the firmware update method and system. Wherein, firstly, the firmware version checking procedure is executed actively in the system idle state. Next, the applicable firmware program is received. Then the firmware program update operation is performed after the received firmware program is verified by the user end. Finally, reboot the system with the latest version firmware program. As such, the firmware program update operation can be achieved without having to go through a computer system, thus facilitating the firmware update operation, and further raising the competitiveness and service life of the system.

Accordingly, an object of the invention is to provide a method and system for updating the firmware by using a digital broadcasting system. As such, upon receiving a new version firmware program through digital broadcasting system, the user must first verify if the firmware update procedure is to be performed, thus accomplishing the related firmware program update operation, hereby facilitating the firmware update of the system.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus is not limitative of the present invention, wherein:

FIG. 1 is a system flowchart of the steps of a firmware update method according to an embodiment of the invention; and

FIG. 2 is a system block diagram of the firmware update system according to an embodiment of the invention.

### DETAILED DESCRIPTION OF THE INVENTION

The purpose, construction, features, and functions of the invention can be appreciated and understood more thoroughly through the following detailed description with reference to the attached drawings.

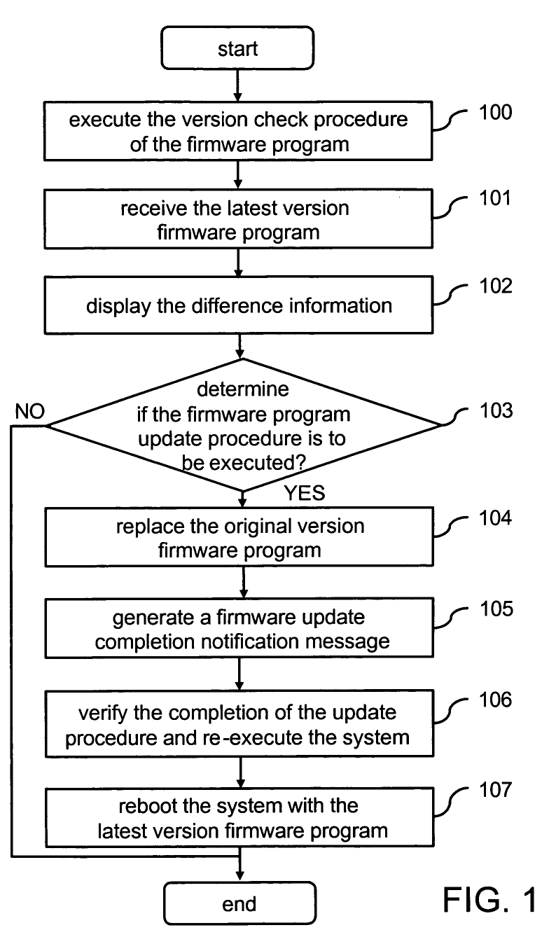

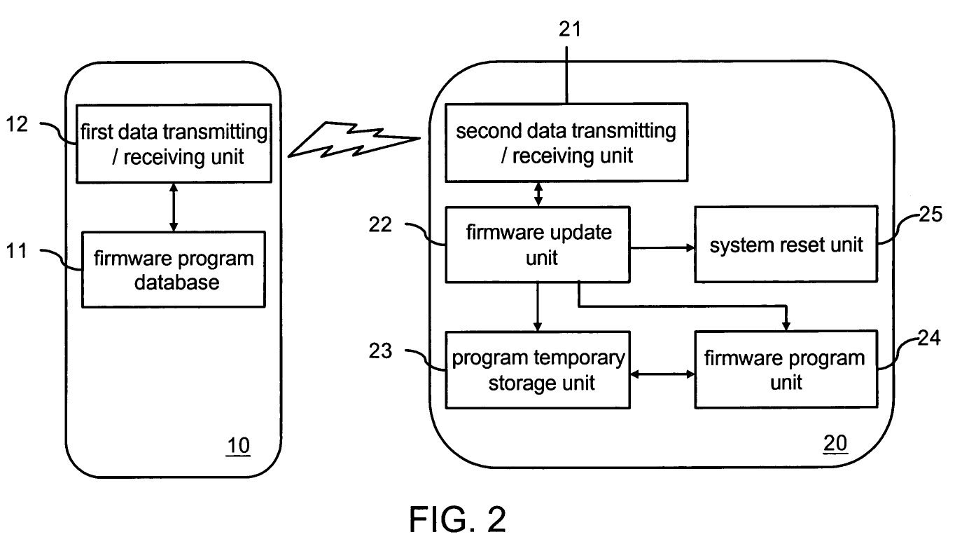

As shown in FIG. 1, it is a system flowchart of the steps of a firmware update method according to an embodiment of the invention. The firmware update method includes the following steps. Firstly, execute the version check procedure of the firmware program while the system is in an idle state (step 100). In practice, this can be achieved through a version check request sent from a user end 20 to a system end 10 shown in FIG. 2, thus obtaining the version information relating to the firmware program. This can be achieved as well through a version update notification message, sent from a system end 10 to a user end 20, hereby activating the version check procedure of the firmware program.

Then, receive the latest version firmware program through a digital broadcasting (for example, digital audio broadcast (DAB) and/or digital video broadcast (DVB)) system (step 101). In practice, the transmit frame of the digital broadcasting system (the digital audio broadcast (DAB) is taken as an example) is composed of the following channels: a Main Service Channel (MSC), used to carry the audio signal and digital data; a Fast Information Channel (FIC), used to carry the transmit frame type real-time message (control message); and a Synchronization Channel, used to synchronize the transmit frames and evaluate the channel status. In this configuration, the firmware program is transmitted via the Main Service Channel (MSC).

Subsequently, display the difference information between the latest version firmware program and the original version firmware program (step 102), namely, list the functional information of the latest version firmware program for reference and selection by the user.

In the present embodiment, the latest version means the next version. In other words, any version that is later than the version of the present firmware program at the user end can be viewed as the latest version. Then, determine if the firmware program update procedure is indeed to be executed (step 103); upon verifying and making sure that the firmware program update procedure is not to be executed, then terminate directly the firmware program update procedure and return to the system idle state.

However, upon verifying and making sure that the firmware program update procedure is to be executed, then replace the original version firmware program with the latest version firmware program (step 104), wherein the firmware program is stored in the non-volatile memory (for example, the Flash Read-Only-Memory (ROM) or the Electrically Erasable Programmable Read-Only-Memory (EEPROM)). In practice, the basic input/output system (BIOS) and the Board Management Control (BMC) device are made of a non-volatile memory.

Upon finishing the firmware program update, generate a firmware update completion notification message (step 105), thus enabling the user end to know the update status of the firmware program. Subsequently, verify the completion of the firmware program update procedure and re-execute the system power-up procedure (step 106). In practice, a reset system is utilized to proceed with the power-up operation, hereby ensuring the completion of the firmware update procedure. And finally, reboot the system with the latest version firmware program (step 107), thus executing the functions and operations as specified by the firmware program.

As shown in FIG. 2, it is a system block diagram of the firmware update system according to an embodiment of the invention, which is utilized to perform the update procedure of the firmware programs at a system end 10 and a user end 20 of a digital broadcasting system. The system end 10 includes: a firmware program database 11 and a first data transmitting/receiving unit 12, of which the details will be described as follows.

The firmware program database 11 is used to store at least a firmware program of the latest version.

The first data transmitting/receiving unit 12 is connected to the firmware program database 11, and used to transmit or receive a firmware program through digital broadcast communication. The firmware program is transmitted via the Main Service Channel (MSC) of a digital broadcasting system.

Moreover, the user end 20 includes a second data transmitting/receiving unit 21, a firmware update unit 22, and a program temporary storage unit 23, a firmware program unit 24, and a system reset unit 25, of which the details will be described as follows.

The second data transmitting/receiving unit 21 is used to communicate with the first data transmitting/receiving unit 12 through the digital broadcast communication, thus receiving or transmitting the firmware programs.

The firmware update unit 22 is connected to the second data transmitting/receiving unit 21 to perform the version check procedure of the firmware program, hereby realizing the update procedure.

The program temporary storage unit 23 is connected to the firmware update unit 22, and is used to temporarily store the latest version of the received firmware program.

The firmware program unit 24 is connected respectively to the firmware update unit 22 and the program temporary storage unit 23, is used to store the latest version firmware program after the completion of the update procedure by the firmware update unit 22. In practice, the firmware program unit 24 is made of a non-volatile memory (for example, the Flash Read-Only-Memory (ROM) or an Electrically Erasable Programmable Read-Only-Memory (EEPROM)).

The system reset unit 25 is connected to the firmware update unit 22, and is used to re-execute a power-up procedure after the completion of the update procedure, thus ensuring the completion of the firmware update procedure.

A digital broadcasting system is used for the application of the firmware update method and system. Firstly, the firmware version checking procedure is executed actively in the system idle state. Next, the applicable firmware program is received. Then, the firmware program update operation is performed after the received firmware program is verified by the user. Finally, the system is rebooted with the latest version firmware program. As such, the firmware program update operation can be achieved without having to go through a computer system, thus facilitating the firmware update operation, and further raising the competitiveness and service life of the system.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A firmware update method utilizing a digital broadcasting system for updating a firmware program through the digital broadcasting system, comprising the following steps:
performing the version check procedure of the firmware program;
receiving the firmware program of the latest version;
verifying the update procedure of the firmware program to be performed;
replacing the firmware program of the original version with the firmware program of the latest version;
verifying the completion of the update procedure, and re-executing a system power-up procedure; and
rebooting the system with the firmware program of the latest version.

2. The firmware update method as claimed in claim 1, wherein in the step of receiving the firmware program of the latest version, the firmware program is transmitted via a Main Service Channel (MSC) of the digital broadcasting system.

3. The firmware update method as claimed in claim 1, further comprising a step of generating a firmware update completion notification message, after the step of replacing the firmware program of the original version with the firmware program of the latest version.

4. The firmware update method as claimed in claim 1, further comprising a step of displaying the difference information between the firmware program of the original version and the firmware program of the latest version, after the step of receiving the firmware program of the latest version.

5. A firmware update system utilizing a digital broadcasting system for performing the update procedure of a firmware program at a system end and a user end of a digital broadcasting system, the system end comprising:
a firmware program database for storing at least a firmware program of the latest version;
a first data transmitting/receiving unit for transmitting or receiving the firmware program through digital broadcast communication;
the user end comprising:
a second data transmitting/receiving unit for transmitting or receiving the firmware program through the digital broadcast communication;
a firmware update unit for performing the version check procedure of the firmware program, thus proceeding with the update procedure;
a program temporary storage unit for temporarily storing the firmware program of the latest version;
a firmware program unit storing the firmware program of the latest version, after the completion of the update procedure by the firmware update unit; and
a system reset unit re-executing a power-up procedure after the completion of the update procedure.

6. The firmware update system as claimed in claim 5, wherein the firmware program unit is a non-volatile memory.

7. The firmware update system as claimed in claim 6 wherein the non-volatile memory is a Flash Read-Only-Memory (ROM) or an Electrically Erasable Programmable Read-Only-Memory (EEPROM).

8. The firmware update system as claimed in claim 5 wherein the firmware program is transmitted via a Main Service Channel (MSC) of the digital broadcasting system.
